(19) United States
(12) Patent Application Publication
(10) Pub. No.: US 2008/0113266 A1
(43) Pub. Date: May 15, 2008

(54) Electrode for lithium secondary batteries having enhanced cycle performance and lithium secondary batteries comprising the same

(75) Inventors: Jung-Ki PARK, Yuseong-ku (KR); Jun-Young LEE, Yuseong-ku (KR); Yong-Min LEE, Yuseong-ku (KR); Joong-Eun SEO, Yuseong-ku (KR)

Correspondence Address: NATH & ASSOCIATES, 112 South West Street, Alexandria, VA, 22314, US

(73) Assignee: KOREA ADVANCED INSTITUTE OF SCIENCE AND TECHNOLOGY, Daejeon (KR)

(21) Appl. No.: 11/979,491

(22) Filed: Nov. 5, 2007

(30) Foreign Application Priority Data
Nov. 13, 2006 (KR) 10-2006-0111674

(51) Int. Cl. H01M 4/48; B05D 1/00; H01M 4/50; H01M 4/52; C07F 7/02

(52) U.S. Cl. 429/215; 252/182.1; 252/510; 427/77; 429/122; 429/217; 429/220; 429/221; 429/223; 429/224; 429/231.8; 429/231.95; 556/465

(57) ABSTRACT

Disclosed are electrodes for lithium secondary batteries having enhanced cycle performance and lithium secondary batteries comprising the same. More particularly, the present invention provides an electrode for lithium secondary battery with improved initial charge/discharge characteristics and cycle life characteristics at high temperature, which includes silane based additives as a constitutional component of the electrode and forms a passivation film during an initial charge/discharge process and, in addition, a lithium secondary battery comprising the above electrode.

### BACKGROUND OF THE INVENTION

This application claims priority to Korean Patent Application No. 2006-0111674, filed on Nov. 13, 2006, in the Korean Intellectual Property Office, the entire contents of which are hereby incorporated by reference.

1. Field of the Invention

The present invention relates to an electrode for lithium secondary battery having enhanced cycle performance and lithium secondary batteries comprising the same, more particularly, to an electrode for a lithium secondary battery with improved initial charge/discharge characteristics and cycle life characteristics at high temperature, which forms a stable solid electrolyte interface (SEI) layer during an initial charging/discharging process and, in addition, a lithium secondary battery comprising the above electrode.

2. Description of the Related Art

There is a recent tendency toward significant increase in demands for secondary batteries necessarily used as power sources of electronic devices in regard to mobile information technologies (IT) such as mobile phones, laptop PCs, PDAs, etc., which are rapidly growing along with fast development of advanced technologies in information and telecommunication fields. Applications of such secondary batteries are also widely extended to other fields such as electric vehicles, robots and electric tools, etc. Such extension of applications induces variation in external appearances and dimensions of the batteries, and requires high energy density, high performance and/or high stability of the batteries.

Under these circumstances, advanced countries including Japan and the USA have aggressively researched and developed the secondary batteries for a long time through their leading roles in national R & D systems and, at present, the secondary batteries standing at the forefront of technology all over the world comprise lithium based secondary batteries.

It is well known that a lithium secondary battery system is one of chemical energy conversion devices which can derive electric energy from free energy change generated by electrochemical oxidation/reduction (usually referred to as “redox reaction”), and that generally comprises a cathode, an anode, a liquid electrolyte consisting of an organic solvent and salts to transport lithium ions and a thin membrane type separator to prevent physical contact between the cathode and the anode. The lithium ions can be intercalated into and de-intercalated from both of the cathode and the anode.

There is a requirement for development of novel improved electrodes for endowing high energy density, high performance and/or high safety to the lithium secondary batteries. New electrode systems preferably include silane based additives to modify the surface of an electrode active material and assist formation of stable passivation film during the initial charging/discharging process.

For a lithium secondary battery, lithium ions are generated from a cathode made of lithium metal oxides, flow to an anode made of graphite during an initial charging process, and are intercalated into the graphite anode. The lithium ions react with other decomposition products such as non-aqueous electrolytes or anions of the salts to form a thin passivation film called a solid electrolyte interface layer (SEI layer) on the surface of the graphite anode. The SEI layer passes lithium ions but prevents transportation of electrons. The lithium ions as well as organic solvent reduction side products of an electrolyte having large molecular weight, both of which are intercalated into the graphite anode, can prevent collapse of a graphite structure of the anode.

Such SEI layer can prevent additional side reaction of the lithium ions with the decomposition products such as the organic solvent or anions of the salts, thereby maintaining the lithium ions during a long charging/discharging process with high discharge capacity. That is, during the initial charging process, charge/discharge characteristics and stability of a battery depend on constitutional components and morphologies of the SEI layer formed on the surface of an anode active material.

Such SEI layer has positive effects as mentioned above. However, if the SEI layer is unstably formed, then against its original purpose, the SEI layer may derive additional decomposition of the organic solvent rather than provide the positive effects. As a result, the battery exhibits a decrease in number of reversibly transferring lithium ions, and reduced discharge capacity and lower efficiency. Such tendencies become more serious as the battery is driven at high temperature.

Accordingly, in order to embody high performance secondary batteries, are required functional materials that decompose earlier than an organic solvent composite portion at a lower potential and form a stable SEI layer. Without the functional materials, it is expected that lithium ions and electrons are consumed in the redox reaction of the organic solvent, which was used during the initial charging process of the battery, so as to increase an irreversible capacity of the battery, and a resisting layer formed in the battery induces continuous decrease of the capacity of the battery during repetitive charging/discharging processes.

Conventional technologies in association with the above invention are mostly related to development of novel electrolytes. For instance, one of known prior arts includes a method for adding an additive to a commercially available electrolyte then determining different properties of the electrolyte. In order to reliably inhibit lowering of battery performance due to the redox reaction of the organic solvent, Japanese Patent Laid-Open No. H7-176323 discloses addition of CO₂ to an electrolyte and Japanese Patent Laid-Open No. H7-320779 discloses a method of adding sulfide based compounds to an electrolyte to inhibit decomposition of the electrolyte. Meanwhile, Korean Patent No. 10-0412527 discloses a process for fabrication of a stable SEI layer by preparing an electrolyte containing vinyl ester based compounds.

As described in the known methods, there have been attempts to form an improved stable passivation film on the surface of an anode by adding a small amount of organic or inorganic materials to the electrolyte to cause the redox reaction of the electrolyte mixture at a lower potential than that of the organic solvent during an initial charging process. Such method uses a large amount of additives to cause a side reaction within a battery and, in turn, lead to reduction in battery performance and economic efficiency. In other words, depending on characteristics of the compound added to the battery, there are problems in that the irreversible capacity of the battery is increased or the compound interacts with carbon moiety in the anode to be decomposed or form an unstable SEI layer. Such tendencies became more serious at higher temperature and/or concentration of the compound.

### SUMMARY OF THE INVENTION

Accordingly, the present invention is directed to solve the problems of conventional methods as described above and, an object of the present invention is to provide an electrode for lithium secondary battery with improved initial charge/discharge characteristics and cycle life characteristics at high temperature, which forms a stable passivation film during an initial charging/discharging process.

Another object of the present invention is to provide a process of preparing an electrode for lithium secondary battery with improved initial charge/discharge characteristics and cycle life characteristics at high temperature by forming a stable passivation film during the initial charging/discharging process.

Still another object of the present invention is to provide a lithium secondary battery with improved initial charge/discharge characteristics and cycle life characteristics at high temperature, comprising a stable passivation film formed during the initial charging/discharging process.

In order to achieve the objects described above, the present invention provides an electrode for lithium secondary battery comprising silane based additives.

The present invention also provides a process for preparation of an electrode for lithium secondary battery by mixing electrode active materials, a conductive material, a binder and a silane based compound in a solvent to form a slurry, applying the slurry to a conductive current collector and drying the coated collector to produce the electrode.

Further, the present invention provides a lithium secondary battery comprising a cathode, an anode, a membrane type separator and a liquid electrolyte, wherein the cathode and/or anode contain(s) silane based additives.

### BRIEF DESCRIPTION OF THE DRAWINGS

These and other objects, features, aspects, and advantages of preferred embodiments of the present invention will be more fully described in the following detailed description, taken in conjunction with the accompanying drawings. In the drawings:

FIG. 1 is a graph illustrating a result of initial charging/discharging test for an electrode with a specific electrode additive according to the present invention, as compared with that of an electrode without the additive; and

FIG. 2 is a graph illustrating cycle life characteristics of the electrode with the additive according to the present invention at 60° C., as compared with that of the electrode without the additive.

### DETAILED DESCRIPTION OF THE INVENTION

Hereafter, the present invention will be described in detail.

An electrode for lithium secondary battery is typically produced by mixing electrode active materials, that is, a cathode active material and an anode active material with a conductive material and/or a binder to prepare an electrode slurry, applying the slurry to an electrode current collector, and then drying the collector to remove or disperse a solvent portion and bind the electrode active materials with the electrode current collector as well as the electrode active materials with each other.

The silane based compound as described above is used as an electrode additive according to the present invention, which improves affinities between the binder and the electrolyte and controls formation of a passivation film because the compound is decomposed earlier than commonly used electrolytes during a charging/discharging process, thereby enhancing initial charge/discharge characteristics and cycle life characteristics at high temperature.

Such silane based compound may be contained in any one or both of the cathode and the anode.

Silane based additives usable in the present invention include compounds represented by the following formula:

XₙSiY₄ₙ (with n ranging from 1 to 3)

wherein X is any one selected from a group comprising of CH₂═CH—, CH₂═(CH₃) COOC₃H₆—, HN₂C₃H₆—, NH₂C₂H₄NHC₃H₆—, NH₂COCHC₃H₆—, CH₃COOC₂H₄NHC₂H₄NHC₃H₆ —, NH₂C₂H₄NHC₂H₄NHC_{c}H₆—, SHC₃H₆—, ClC₃H₆—, CH₃—, CH₂H₅—, C₂H₅OCONHC₃H₆—, OCNC₃H₆—, C₆H₅—, C₆H₅CH₂NHC₃H₆—, C₃H₅NC₃H₆—, H— and halogens; and

Y is any one selected from: an alkyl, alkoxy, acetoxy or cycloalkyl group which is possibly substituted by any of functional groups selected from a group comprising of —H, halogens, an aryl group, an aralkyl group and an allyl group; a phenyl group being substituted by halogens; and —OC₂H₄OCH₃, —Si(CH₃)₃, —OSi(CH₃)₃, —OSi(CH₃)₂H, —O(CH₂CH₂O)ₘCH₃ (with m ranging from 1 to 10), —N(CH₃)₂ and halogens. The substitutable functional groups are not particularly limited but include, for example: any group with 1 to 3 aromatic rings such as a phenyl or naphthyl group as the aryl group; and a group with 1 to 10 carbon atoms as the aralkyl group and allyl group.

Alkyl, alkoxy and acetoxy groups are not particularly limited but include any group having 1 to 10 carbon atoms. A cycloalkyl group includes any group having 3 to 12 carbon atoms.

Content of the silane based additive ranges from 0.1 to 10% by weight relative to total weight of the electrode materials.

The cathode active material used in the present invention is not particularly limited as far as it can absorb and discharge lithium. For example, the cathode active material includes: LiCoO₂; LiNiO₂; LiMn₂O₄; LiMnO₂; LiCoPO₄; LiNi₍₁₋ₓ₎CoₓM_{y}O₂ wherein M is Al, Ti, Mg or Zr, X is 0<X≦1, and Y is 0≦Y≦0.2; LiNiₓCo_{y}Mn_{(1-x-y)}O₂ wherein x is 0<x≦0.5 and y is 0<y≦0.5; and LiMₓM′_{y}Mn_{(2-x-y)}O₄ wherein each of M and M′ is V, Cr, Fe, Co, Ni or Cu, x is 0<x≦1, and y is 0<y≦1, but is not limited thereto. The above materials are used solely or in combination of two or more thereof.

The anode active material used in the present invention is not particularly limited as far as it can absorb and discharge lithium. For example, the anode active material includes metals and/or alloys such as lithium alloy, carbon, coke, activated carbon, graphite, silicon (Si), tin (Sn), etc.

The conductive material is used for promoting conductive contact between the electrode materials and includes any materials without limitation as far as they have high electric conductivity and large specific surface area. For example, the conductive material preferably includes carbon black such as acetylene black, ketjen black, furnace black or thermal black, natural graphite, artificial graphite, etc.

The binder used in the present invention may comprise any one of thermoplastic resin and thermosetting resin alone or in combination thereof. Representative examples of the binder include polyvinylidene fluoride (PVdF) or copolymer thereof, polytetrafluoroethylene (PTFE), styrene-butadiene rubber (SBR) and so on.

Representative examples of the dispersing solvent used in the present invention include isopropyl alcohol, N-methyl pyrrolidone (NMP), acetone, water and the like.

The conductive current collector generally includes high conductivity metals. However, the conductive current collector according to the present invention is not particularly limited but includes any materials as far as they are the metals easily adhered with the electrode slurry and not reactive in the range of cell voltage of the battery. Representative examples of the conductive current collector include meshes or foils made of aluminum, copper, nickel, stainless steel or the like.

The lithium secondary battery according to the present invention can be fabricated by any conventional methods known in the related art that interpose a separator between the cathode and the anode and introduce an electrolyte therein.

The electrolyte used in the present invention is a non-aqueous electrolyte comprising lithium salts and an organic solvent. The lithium salts are at least one compound selected from a group comprising of LiClO₄, LiCF₃SO₃, LiAsF₆, LiBF₄, LiN(CF₃SO₂)₂, LiPF₆, LiSCN, LiC(CF₃SO₂)₃ and LiBOB. The organic solvent is at least one, two or more solvent composite(s) selected from a group comprising of ethylene carbonate (EC), propylene carbonate (PC), dimethyl carbonate (DMC), diethyl carbonate (DEC), gamma-butyrolactone (γBL), ethylmethyl carbonate (EMC), dimethoxyethane (DME), diethoxyethane (DEE), 2-methyl tetrahydrofuran (2-MeTHF) and dimethyl sulfoxide.

A mixing ratio of the organic solvent to the electrolyte is not particularly limited but complies with a typical range for preparation of non-aqueous electrolytes used in manufacturing conventional lithium batteries.

In fabrication of the lithium secondary battery according to the present invention, the membrane type separator may be made of polyolefin materials such as polyethylene or polypropylene but, is not particularly limited thereto.

The lithium secondary battery is not particularly limited in external design or appearance thereof, but includes circular or angular can type, pouch type or coin type batteries.

The present invention will become apparent from the following examples, comparative examples and experimental examples with reference to the accompanying drawings. However, these are intended to illustrate the invention as preferred embodiments of the present invention and do not limit the scope of the present invention.

### EXAMPLE 1

### Preparation of Electrode Containing Silane Based Compound and Lithium Secondary Battery

1. Fabrication of Cathode

85% by weight (abbreviated to “wt. %”) of LiCoO₂ as a cathode active material, 8 wt. % of carbon black as a conductive material and 7 wt. % of PVdF as a binder were added to N-methyl pyrrolidone (NMP) as a dispersing solvent to prepare a slurry mixture. The slurry mixture was applied to an aluminum (Al) thin film as a cathode current collector and dried to form a cathode, followed by roll pressing of the cathode.

2. Fabrication of Anode

92 wt. % of graphite powder as an anode active material, 5 wt. % of PVdF as the binder and 3 wt. % of vinylsilane as an additive were added to NMP to prepare an anode slurry. The anode slurry was applied to a copper (Cu) thin film as an anode current collector and dried to form an anode, followed by roll pressing of the anode.

3. Fabrication of Battery

Each of the cathode and anode prepared above was cut into a size of 2 cm×2 cm and combined and assembled with a polyethylene membrane type separator and an organic electrolyte to form a lithium secondary battery, the organic electrolyte comprising ethylene carbonate and dimethyl carbonate in a ratio by volume of 1:1 (EC/DMC).

### COMPARATIVE EXAMPLE 1

A battery was fabricated by preparing the cathode and the anode in the same manner as in Example 1, except that vinylsilane was not added to the anode slurry.

### EXPERIMENTAL EXAMPLE 1

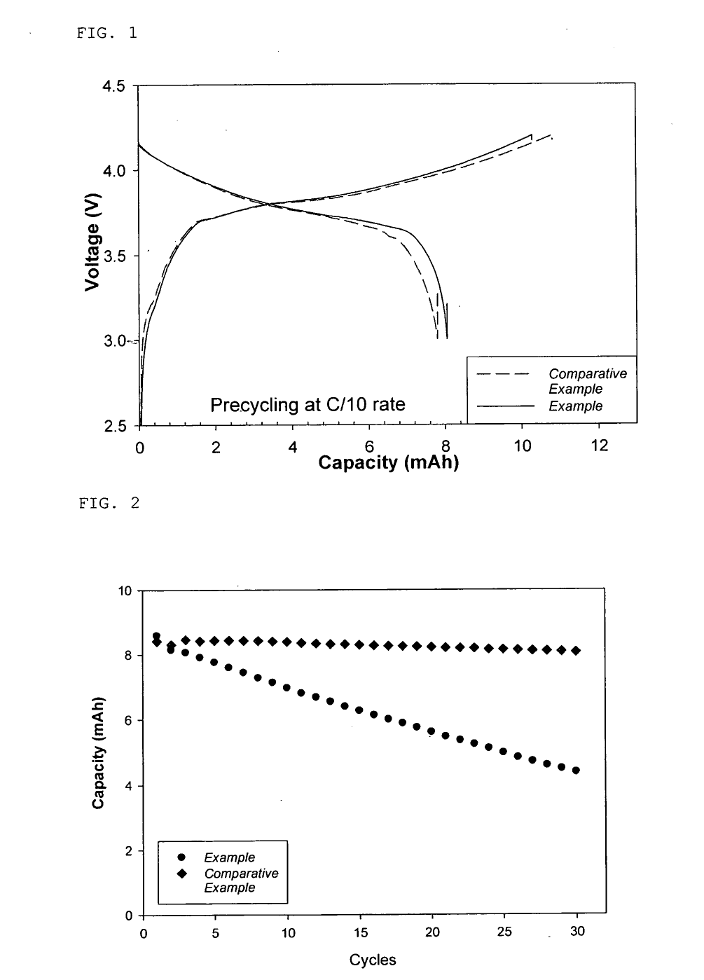

After charging the battery fabricated in Example 1 with C/10 current and a cell voltage of 4.2V under a condition of constant current (CC), the battery underwent a discharging process to 3.0V using C/10 current. Initial discharge capacity of the battery was measured. The result is shown in the following Table 1 and FIG. 1.

### COMPARATIVE EXPERIMENTAL EXAMPLE 1

After charging the battery fabricated in Comparative Example 1 with C/10 current and a cell voltage of 4.2V under the constant current (CC) condition, the battery underwent a discharging process to 3.0V using C/10 current. Initial discharge capacity of the battery was measured. The result is shown in the following Table 1 and FIG. 1.

Table 1 is result of initial discharge capacity compared with experimental example 1 and comparative experimental example 1.

FIG. 1 is a graph for illustrating the initial charge/discharge capacity of the battery prepared in Example 1 according to the present invention, as compared with that of the battery prepared in Comparative Example 1.

TABLE 1

| | Comparative | Experimental |
|---|---|---|
| | experimental example 1 | example 1 |
| Initial discharge | 7.8 | 8.1 |
| capacity (mAh) | | |

### EXPERIMENTAL EXAMPLE 2

In order to understand charge/discharge characteristics of the battery fabricated in Example 1 under different conditions, the battery was charged with C/2 current and a cell voltage of 4.2V at room temperature under a condition of constant current and constant voltage (CC-CV), then, discharged to 3.0V with C/2 current under the CC condition. Alternatively, the battery was subjected to the charging/discharging process at a high temperature of 60° C. under the same condition.

### COMPARATIVE EXPERIMENTAL EXAMPLE 2

In order to understand charge/discharge characteristics of the battery fabricated in comparative Example 1 under different conditions, the battery was charged with C/2 current and a cell voltage of 4.2V at room temperature under the CC-CV condition, then, discharged to 3.0V with C/2 current under the CC condition. Alternatively, the battery was subjected to the charging/discharging process at a high temperature of 60° C. under the same condition.

The results of Experimental Example 2 and Comparative Experimental Example 2 are shown in FIG. 2, which illustrates variation in current capacity according to cycles at high temperature.

As identified from Table 1, it was proved that the lithium secondary battery of the present invention has improved initial charge/discharge characteristics. From FIG. 2, it was also demonstrated that the present invention can enhance high temperature charge/discharge characteristics.

As described above, the electrode for lithium secondary battery of the present invention can enhance initial charge/discharge characteristics and cycle life characteristics of a battery at high temperature by forming a stable passivation film during an initial charging/discharging process of the battery. Even when the electrode of the present invention is adapted to an electrolyte containing lithium salts with low thermal resistance, the battery comprising this electrolyte exhibits excellent charge/discharge characteristics during a high temperature charging/discharging process and, in addition, improved high rate charge/discharge characteristics.

While the present invention has been described with reference to the preferred embodiments and examples, it will be understood by those skilled in the art that various modifications and variations may be made therein without departing from the scope of the present invention as defined by the appended claims.

What is claimed is:

1. An electrode for lithium secondary batteries comprising silane based additives.

2. The electrode according to claim 1, wherein the silane based additives are selected from compounds represented by the following formula:
XₙSiY₄₋ₙ (with n ranging from 1 to 3)
wherein X is any one selected from a group comprising of CH₂═CH—, CH₂═(CH₃)COOC₃H₆—, HN₂C₃H₆—, NH₂C₂H₄NHC₃H₆—, NH₂COCHC₃H₆—, CH₃COOC₂H₄NHC₂H₄NHC₃H₆—, NH₂C₂H₄NHC₂H₄NHC₃H₆—, SHC₃H₆—, ClC₃H₆—, CH₃—, CH₂H₅—, C₂H₅OCONHC₃H₆—, OCNC₃H₆—, C₆H₅—, C₆H₅CH₂NHC₃H₆—, C₃H₅NC₃H₆—, H— and halogens; and
Y is any one selected from: an alkyl, alkoxy, acetoxy or cycloalkyl group which is possibly substituted by any of functional groups selected from a group comprising of —H, halogens, an aryl group, an aralkyl group and an allyl group; a phenyl group being substituted by halogens; and —OC₂H₄OCH₃, —Si(CH₃)₃, —OSi(CH₃)₃, —OSi(CH₃)₂H, —O (CH₂CH₂O)ₘCH₃ (with m ranging from 1 to 10), —N(CH₃)₂ and halogens.

3. The electrode according to claim 1, wherein content of the silane based additives ranges from 0.1 to 10 wt. % relative to total weight of electrode materials.

4. The electrode according to claim 1, further comprising electrode active materials which include,
(A) a cathode active material comprising at least one selected from a group comprising of: LiCoO₂; LiNiO₂; LiMn₂O₄; LiMnO₂; LiCoPO₄; LiNi₍₁₋ₓ₎CoₓM_{y}O₂ wherein M is Al, Ti, Mg or Zr, X is 0<X≦1, and Y is 0≦Y≦0.2; LiNiₓCo_{y}Mn_{(1-x-y)}O₂ wherein x is 0<x≦0.5 and y is 0<y≦0.5; and LiMₓM′_{y}Mn_{(2-x-y)}O₄ wherein each of M and M′ is V, Cr, Fe, Co, Ni or Cu, x is 0<x≦1, and y is 0<y≦1, and
(B) an anode active material comprising at least one selected from a group comprising of lithium alloy, carbon, coke, activated carbon, graphite, silicon (Si), metals and/or alloys thereof.

5. The electrode according to claim 1, wherein a conductive material contained in the electrode materials is at least one selected from a group comprising of carbon black, natural graphite and artificial graphite.

6. The electrode according to claim 1, wherein a binder contained in the electrode materials is at least one selected from a group comprising of polyvinylidene fluoride or copolymer thereof, polytetrafluoroethylene and styrene-butadiene rubber.

7. The electrode according to claim 1, wherein a conductive current collector for fabricating the battery comprises meshes or foils.

8. A process of preparing an electrode for lithium secondary battery, comprising: mixing electrode active materials, a conductive material, a binder and a silane based compound in a solvent to form a slurry; and applying the slurry to a conductive current collector then drying the collector.

9. The process according to claim 8, wherein the silane based compound as a silane based additive is selected from compounds represented by the following formula:
XₙSiY₄₋ₙ (with n ranging from 1 to 3)
wherein X is any one selected from a group comprising of CH₂═CH—, CH₂═(CH₃)COOC₃H₆—, HN₂C₃H₆—, NH₂C₂H₄NHC₃H₆—, NH₂COCHC₃H₆—, CH₃COOC₂H₄NHC₂H₄NHC₃H₆—, NH₂C₂H₄NHC₂H₄NHC₃H₆—, SHC₃H₆—, ClC₃H₆—, CH₃—, CH₂H₅—, C₂H₅OCONHC₃H₆—, OCNC₃H₆—, C₆H₅—, C₆H₅CH₂NHC₃H₆—, C₃H₅NC₃H₆—, H— and halogens; and
Y is any one selected from: an alkyl, alkoxy, acetoxy or cycloalkyl group which is possibly substituted by any of functional groups selected from a group comprising of —H, halogens, an aryl group, an aralkyl group and an allyl group; a phenyl group being substituted by halogens; and —OC₂H₄OCH₃, —Si(CH₃)₃, —OSi(CH₃)₃, —OSi(CH₃)₂H, —O(CH₂CH₂O)ₘCH₃ (with m ranging from 1 to 10), —N(CH₃)₂ and halogens.

10. The process according to claim 8, wherein content of the silane based additive ranges from 0.1 to 10 wt. % relative to total weight of electrode materials.

11. The process according to claim 8, wherein the electrode active materials include,
(A) a cathode active material comprising at least one selected from a group consisting of: LiCoO₂; LiNiO₂; LiMn₂O₄; LiMnO₂; LiCoPO₄; LiNi₍₁₋ₓ₎CoₓM_{y}O₂ wherein M is Al, Ti, Mg or Zr, X is 0<X≦1, and Y is 0≦Y≦0.2; LiNiₓCo_{y}Mn_{(1-x-y)}O₂ wherein x is 0<x≦0.5 and y is 0<y≦0.5; and LiMₓM′_{y}Mn_{(2-x-y)}O₄ wherein each of M and M′ is V, Cr, Fe, Co, Ni or Cu, x is 0<x≦1, and y is 0<y≦1, and
(B) an anode active material comprising at least one selected from a group consisting of lithium alloy, carbon, coke, activated carbon, graphite, Si, metals and/or alloys thereof.

12. The process according to claim 8, wherein the conductive material contained in the electrode materials is at least one selected from a group comprising of carbon black, natural graphite and artificial graphite.

13. The process according to claim 8, wherein the binder contained in the electrode materials is at least one selected from a group comprising of polyvinylidene fluoride or copolymer thereof, polytetrafluoroethylene and styrene-butadiene rubber.

14. The process according to claim 8, wherein the current collector for fabricating the battery comprises meshes or foils.

15. A lithium secondary battery comprising a cathode, an anode, a membrane type separator and an electrolyte, wherein both of the cathode and the anode contain silane based additives.

16. The battery according to claim 15, wherein the silane based additives are selected from compounds represented by the following formula:
XₙSiY₄₋ₙ (with n ranging from 1 to 3)
wherein X is any one selected from a group comprising of CH₂═CH—, CH₂═(CH₃)COOC₃H₆—, HN₂C₃H₆—, NH₂C₂H₄NHC₃H₆—, NH₂COCHC₃H₆—, CH₃COOC₂H₄NHC₂H₄NHC₃H₆—, NH₂C₂H₄NHC₂H₄NHC₃H₆—, SHC₃H₆—, ClC₃H₆—, CH₃—, CH₂H₅—, C₂H₅OCONHC₃H₆—, OCNC₃H₆—, C₆H₅—, C₆H₅CH₂NHC₃H₆—, C₃H₅NC₃H₆—, H— and halogens; and
Y is any one selected from: an alkyl, alkoxy, acetoxy or cycloalkyl group which is possibly substituted by any of functional groups selected from a group comprising of —H, halogens, an aryl group, an aralkyl group and an allyl group; a phenyl group being substituted by halogens; and —OC₂H₄OCH₃, —Si(CH₃)₃, —OSi(CH₃)₃, —OSi(CH₃)₂H, —O(CH₂CH₂O)ₘCH₃ (with m ranging from 1 to 10), —N(CH₃)₂ and halogens.

17. The battery according to claim 15, wherein content of the silane based additives ranges from 0.1 to 10 wt. % relative to total weight of electrode materials.

18. The battery according to claim 15, wherein the cathode and the anode contain electrode active materials which include,
(A) a cathode active material comprising at least one selected from a group consisting of: LiCoO₂; LiNiO₂; LiMn₂O₄; LiMnO₂; LiCoPO₄; LiNi₍₁₋ₓ₎CoₓM_{y}O₂ wherein M is Al, Ti, Mg or Zr, X is 0<X≦1, and Y is 0≦Y≦0.2; LiNiₓCo_{y}Mn_{(1-x-y)}O₂ wherein x is 0<x≦0.5 and y is 0<y≦0.5; and LiMₓM′_{y}Mn_{(2-x-y)}O₄ wherein each of M and M′ is V, Cr, Fe, Co, Ni or Cu, x is 0<x≦1, and y is 0<y≦1, and
(B) an anode active material comprising at least one selected from a group consisting of lithium alloy, carbon, coke, activated carbon, graphite, Si, metals and/or alloys thereof.

19. The battery according to claim 15, wherein a conductive material contained in the electrode materials is at least one selected from a group comprising of carbon black, natural graphite and artificial graphite.

20. The battery according to claim 15, wherein a binder contained in the electrode materials is at least one selected from a group comprising of polyvinylidene fluoride or copolymer thereof, polytetrafluoroethylene and styrene-butadiene rubber.

21. The battery according to claim 15, wherein a conductive current collector for fabricating the battery comprises meshes or foils.
